(19) United States
(12) Patent Application Publication
(10) Pub. No.: US 2014/0160937 A1
(43) Pub. Date: Jun. 12, 2014

(54) COMMON RADIO RESOURCE CONTROL FOR CELLULAR RADIO AND WIFI

(71) Applicant: TELEFONAKTIEBOLAGET L M ERICSSON (PUBL), Stockholm (SE)

(72) Inventor: Christopher RICHARDS, Ottawa (CA)

(73) Assignee: Telefonaktiebolaget L M Ericsson (publ), Stockholm (SE)

(21) Appl. No.: 13/707,184

(22) Filed: Dec. 6, 2012

(51) Int. Cl. H04W 72/04; H04W 12/06; H04W 24/00; H04W 52/02; H04W 36/30; H04W 36/14; H04W 28/08

(52) U.S. Cl. CPC H04W 72/0433; H04W 36/14; H04W 12/06; H04W 28/08; H04W 52/0212; H04W 36/30; H04W 24/00
USPC 370/236; 370/329; 370/331; 370/241.1; 370/311

(57) ABSTRACT

A method and system for combined control and management of radio resources of a cellular radio network and a WiFi network are disclosed. According to one aspect, a method includes performing, by a combined radio resource control unit, radio resource control functions controlling utilization of radio resources of the cellular radio network and the WiFi network. The method includes establishing communication between the combined radio resource control unit and 1) at least one cellular radio base station 2) at least one WiFi access point and 3) a backhaul communication network.

### TECHNICAL FIELD

The present invention relates to a method and system for common control of cellular radio network functions and WiFi network functions.

### BACKGROUND

WiFi, also termed WLAN, has become a ubiquitous wireless technology for data communication in the unlicensed radio spectrum. The Institute of Electrical and Electronic Engineers, IEEE, standard IEEE 802.11 defines the protocol stack and functions used by WiFi access points, APs. In the licensed radio spectrum 3^{rd} generation partnership project, long term evolution, 3GPP LTE, wireless communication technology is rapidly being deployed. LTE is the 4^{th} generation of wireless cellular communications. The protocol stack of LTE is currently defined by the 3GPP. The rapid increase in cellular data usage has prompted wireless operators to turn to using WiFi as a means to offload traffic from the congested licensed radio spectrum.

Referring now to the drawing figures, there is shown in FIG. 1 a known cellular radio network 10 and a known WiFi network 20. Each of networks 10 and 20 are independent of the other. The cellular radio network includes a plurality of base stations 12 that contain radios that communicate over a defined geographic area called a cell. The base stations 12 may be, for example, evolved Node B, eNB, base stations of an evolved Universal Terrestrial Radio Access Network, eUTRAN, or LTE network. The air interface of the base stations 12 may be orthogonal frequency division multiple access, OFDMA, on the downlink, and single carrier frequency division multiple access, SC-OFDMA, on the uplink.

Each base station 12 may be in communication with a serving gateway S-GW 14 using an S1 protocol. The S-GW 14 is a communication interface between the base stations 12 and the Internet and/or a backhaul network. As such S-GW 14 routes and forwards user data packets, while also acting as the mobility anchor for the user plane during inter-eNB handovers and as the anchor for mobility between LTE and other 3GPP technologies.

The base stations 12 are also in communication with a mobile management entity, MME, 16. The MME 16 is the key control-node for the LTE access-network. The MME 16 is responsible for idle mode UE, User Equipment, tracking and paging procedure including retransmissions. The MME 16 is involved in the bearer activation/deactivation process and is also responsible for choosing the S-GW 14 for a UE at the UE's initial entry into the LTE network and at time of intra-LTE handover.

The MME 16 is responsible for authenticating the user, for generation and allocation of temporary identities to UEs, for authorization of the UE to camp on the service provider's Public Land Mobile Network (PLMN) and enforces UE roaming restrictions. The MME is the termination point in the network for ciphering/integrity protection for non-access stratum, NAS, signaling and handles security key management. Lawful interception of signaling is also supported by the MME 16. Further, the MME 16 also provides the control plane function for mobility between LTE and second generation/third generation, 2G/3G, access networks.

The WiFi network 20 includes wireless access points 22. Each WiFi access point functions as a communication interface between a user equipment, such as a computer, and the Internet. The coverage of one or more (interconnected) access points—called hotspots—can extend from an area as small as a few rooms to as large as many square miles. Coverage in the larger area may require a group of access points with overlapping coverage.

Cellular radio networks, such as the communication network 10, and the WiFi network 20 utilize two independent radio air interfaces and networks, each with their own operations, administration and management, OAM, infrastructure. For example, a user's LTE and WiFi subscriptions and profiles are retrieved using different mechanisms from a centralized database. Likewise, the mechanisms for authenticating device access to the network and securing the subscribers data is different between the two wireless technologies, LTE and WiFi.

Additionally, since the two network architectures are separated, the ability to perform fast and reliable mobility of subscriber data sessions between the two networks is severely limited. For example, seamless roaming from LTE to WiFi and back without loss of data packets is a hugely complex task with today's separate networks.

Furthermore, since one of the motivations of supplementing LTE network capacity with WiFi is to autonomously offload data traffic, the network nodes that must make the decision to move end user sessions from one network to another, i.e. the LTE eNodeB and the WiFi AP, currently have no means of determining the ability of the other network node to receive the offloaded traffic.

### SUMMARY

The present invention advantageously provides a method and system for combined control and management of radio resources of a cellular radio network and a WiFi network. According to one aspect, the invention provides a method that includes performing, by a combined radio resource control system, radio resource control functions controlling utilization of radio resources of the cellular radio network and the WiFi network. The method includes establishing communication between the combined radio resource control system and 1) at least one cellular radio base station 2) at least one WiFi access point and 3) a backhaul communication network.

According to one embodiment of this aspect, the radio resource control functions include mobility functions performed to handoff a user equipment from one of the at least one cellular radio base stations to one of at the least one WiFi access points. Conversely, the radio resource control functions may include mobility functions performed to handoff a user equipment from one of the at least one WiFi access points to one of the at least one cellular radio base stations. In some embodiments, the radio resource control functions include authentication functions performed to authenticate a user equipment to the cellular radio network and to authenticate a user equipment to the WiFi network. According to one embodiment, the radio resource control functions include load balancing functions to allocate traffic between the cellular radio network and the WiFi network. In some embodiments, the radio resource control functions include operations, administration and maintenance functions performed in relation to packets received from at least one of the at least one cellular radio base station and from at least one of the at least one WiFi access point. In such embodiments, the operations, administration and maintenance functions may include at least one of billing, security and tracing of packets transmitted by the at least one cellular radio base station and by the at least one WiFi access point. In one embodiment, the radio resource control functions include power saving functions performed to conserve power in user equipment accessing at least one cellular radio base station and in user equipment accessing at least one WiFi access point. In some embodiments, the radio resource control functions include admission control functions performed to admit a user equipment to the cellular radio network and to the WiFi network.

According to another aspect, the invention provides a combined radio resource control unit to control and manage radio resources of a cellular radio network associated with at least one cellular radio base station and a WiFi network associated with at least one WiFi access point. The combined radio resource control unit includes a communication interface configured to communicate with the at least one WiFi access point according to a WiFi compatible protocol and to communicate with the at least one cellular radio base station according to a cellular radio compatible protocol. A translator is configured to translate packets received from the at least one WiFi access point to packets compatible with a first communication protocol. A radio resource controller configured to perform radio resource control functions for both the cellular radio network and the WiFi network according to the first communication protocol. In one embodiment, the first protocol is the cellular radio compatible protocol.

In some embodiments, the radio resource controller includes a mobility management unit configured to perform handoff of a user equipment between the cellular radio network and the WiFi network. In some embodiments, the radio resource controller includes an authentication unit to authenticate a user equipment to the cellular radio network and to authenticate a user equipment to the WiFi network. In some embodiments, the radio resource controller includes a load balancing unit to balance a load on the cellular radio network with a load on the WiFi network. In some embodiments, wherein the radio resource controller includes an operations, administration and maintenance, OAM, unit to perform operations, administration and maintenance functions in relation to packets received from the cellular radio network and from the WiFi network. In some embodiments the combined radio resource control unit further comprises a packet data convergence protocol unit operable to compress, and decompress, IP headers of packets transmitted to, and received from, the translator, respectively.

According to another aspect, the invention provides a radio resource controller that includes a memory and a processor. The memory is configured to store first data corresponding to a first load on a cellular radio base station of a cellular radio network. The memory is also configured to store second data corresponding to a second load on a WiFi access point of a WiFi network. The processor is configured to determine a reallocation of traffic between the cellular radio base station and the WiFi access point based on the first and second data.

According to this aspect, in one embodiment, the memory is further configured to store first authentication data for determining authentication of a user equipment to access the cellular radio network. The memory is also further configured to store second authentication data for determining authentication of the user equipment to access the WiFi network. In this embodiment, the processor is further configured to authenticate the user equipment to the cellular radio network based on the first authentication data. The processor is further configured to authenticate the user equipment to the WiFi network based on the second authentication data. In one embodiment, the memory is further configured to store first channel quality information for a first channel of the cellular radio base station, and is further configured to store second channel quality information for a second channel of the WiFi access point. In this embodiment, the processor is further configured to perform a handoff of a user equipment between the first channel and the second channel based on the first channel quality information and the second channel quality information. In one embodiment, the memory is further configured to store first operations, administration and maintenance, OAM, data concerning packets from the cellular radio base station. The memory is further configured to store second OAM data concerning packets from the WiFi access point. In this embodiment is further configured to perform OAM functions based on the first OAM data and the second OAM data.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a diagram of a known cellular radio network and a known WiFi network;

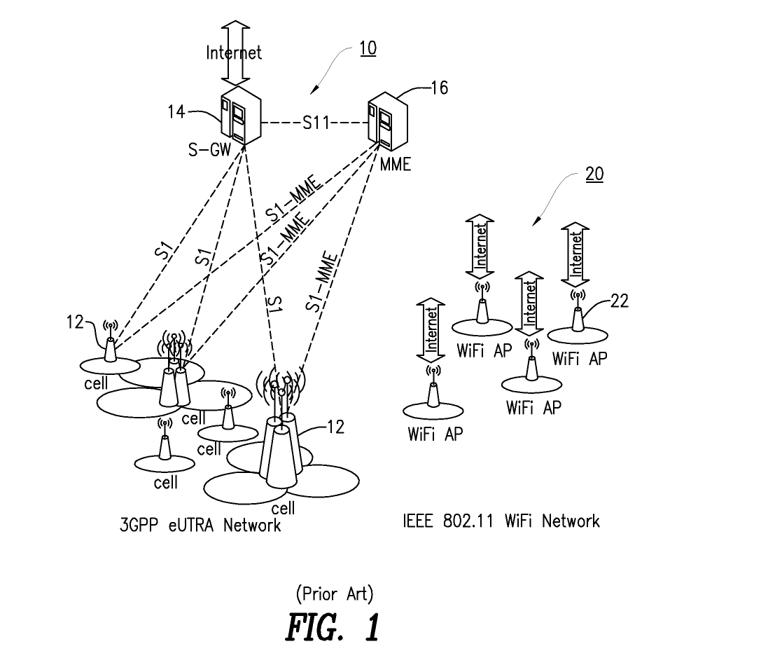

FIG. 2 is a block diagram of a combined radio resource control unit constructed in accordance with principles of the present invention;

FIG. 3 is a block diagram of a radio resource controller constructed in accordance with principles of the present invention;

FIG. 4 is a flowchart of an exemplary process for combining radio resource control of cellular radio resources and WiFi resources.

### DETAILED DESCRIPTION

Before describing in detail exemplary embodiments that are in accordance with the present invention, it is noted that the embodiments reside primarily in combinations of apparatus components and processing steps related providing common control of cellular radio network functions and WiFi network functions. Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

Embodiments described herein combine radio resource and end user session handling—including mobility—of a cellular radio communication network, such as LTE, with a WiFi communication network, so that a single unit controls and manages these functions for both networks. The combined radio resource and session handling functions are implemented in a radio resource controller, RRC. For the sake of brevity, the RRC discussed herein will be described as being implemented in the cellular radio network, although in some embodiments it is contemplated that the RRC may be implemented in the WiFi network. By combining the two radio access technologies, RAT,—cellular radio and WiFi—within a single RRC, data packets for each RAT may use the same transport network toward the backhaul. End user packets are handled by, for example, the cellular radio network infrastructure—for example, billing, security, and tracing—regardless of which RAT originated the packets.

As user devices move between the cellular radio network and the WiFi network, there is a common management of the user session of the device. Collection of charging data, data security and session tracing is done once, regardless of to which air interface technology the user device is currently attached. Even if the user device is only connected to the WiFi access point, the user device will have session state in the RRC, such that the session can be traced and charged the same as a cellular radio session.

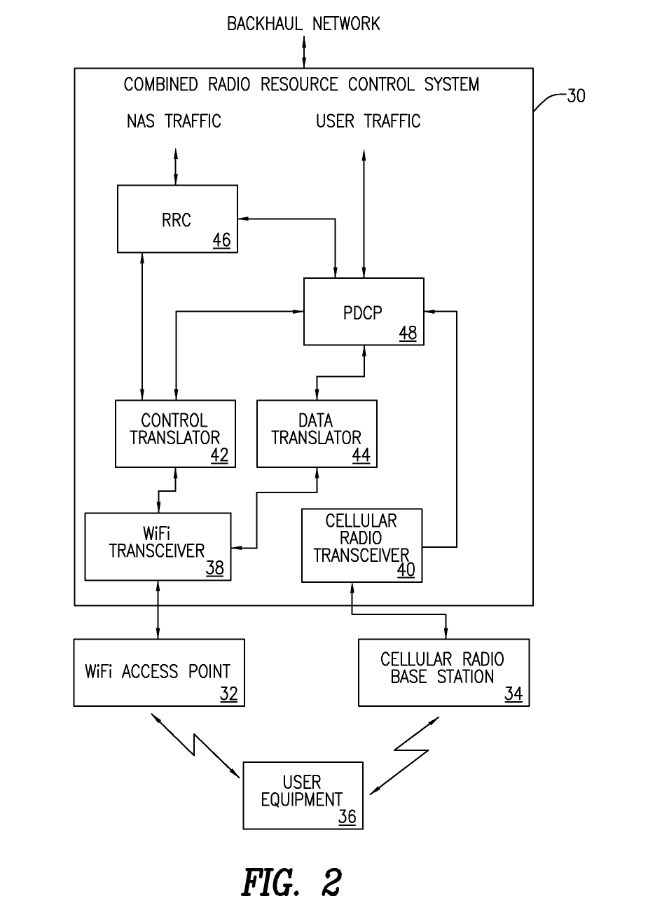

Returning now to the drawing figures, there is shown in FIG. 2 a block diagram of a combined radio resource control system 30 constructed in accordance with principles of the present invention. The combined radio resource control unit 30 is configured to communicate with a WiFi access point 32 and a cellular radio base station 34 such as a 3GPP base station. The WiFi access point 32 and the cellular radio base station 34 may be in communication with one or more user equipment 36. The user equipment 36 has both cellular radio electronics and WiFi electronics, enabling the user equipment to communicate with a cellular radio network and a WiFi network, simultaneously or one at a time.

The combined radio resource control unit 30 includes a WiFi-compatible transceiver 38 that communicates with one or more WiFi access points 32 and includes a cellular radio transceiver 40 that communicates with one or more cellular radio base stations 34. The principles of the present invention described herein can be applied to cellular radio networks such as 3GPP 4^{th} generation, LTE, cellular radio networks. Further, although the combined radio resource control unit 30 is shown separately, in some embodiments, the combined radio resource control unit 30 may be implemented at a WiFi access point 32 or at a cellular radio base station 34. Further, although the combined radio resource control unit is shown as a single unit, the functions of the combined radio resource control unit may be distributed in a system whose components are a set of hardware and software entities at one or more locations.

The combined radio resource control unit 30 includes a control translator 42 that extracts control plane information from WiFi-compatible packets received from the WiFi transceiver 38 and recasts the extracted control plane information into a form that is compatible with the cellular radio network packet protocol, e.g., a 3GPP packet protocol. The translated control plane information is forwarded to a radio resource controller, RRC, 46 and a packet data convergence protocol, PDCP, unit 48.

The combined radio resource control unit 30 also includes a data translator 44. The data translator 44 extracts data from WiFi-compatible packets received from the WiFi transceiver 38 and recasts the extracted data into a form that is compatible with the cellular radio network packet protocol. The recast extracted data is forwarded to the PDCP unit 48. Conversely, data from the PDCP unit 48 is received at the data translator 44 and converted to WiFi-compatible packet data and sent to the WiFi transceiver 38.

Thus, embodiments provide a translation function that ensures that messages and data packets are sent by the combined radio resource control unit 30 in the format expected by the WiFi network and converts messages received from the WiFi network into a format useable by the RRC 46 and the PDCP unit 48. Conversely, the translation function can translate packets in a cellular radio network format to a WiFi compatible format to be processed by an RRC in a WiFi network node.

The PDCP unit 48 performs IP header compression and decompression and transfer of user data to the RRC 46. The PDCP 48 operates on packets that are compatible with the cellular radiocompatible protocol. The PDCP 48 also outputs user data destined for a backhaul network. Similarly, the RRC 46 operates on packets that are compatible with the cellular radio-compatible protocol. Thus, control of a WiFi network can be combined with control of other cellular radio technologies according to the methods described herein.

The RRC 46 functions to provide control and management to both the WiFi network and the cellular radio network air interfaces and outputs control data to non-access stratum signaling carried by the backhaul unit. The RRC 46 can manage many cellular radio cells and WiFi cells simultaneously. The RRC 46 manages end user sessions regardless of which of the two RATS are serving the user equipment. In fact, the user session may be attached to both technologies simultaneously, allowing the RRC 46 to determine the most appropriate radio interface to use for the user's data traffic.

Thus, the RRC 46 functions as if the WiFi and cellular radio interfaces are peer cells, leaving the differences in the lower layer implementations to the specific air interface functions of the WiFi transceiver 38 and the cellular radio transceiver 40. With this approach, radio cell management and control for both the cellular radio network and the WiFi network can be performed by the existing cellular radio network OAM infrastructure, e.g., end user device and subscriber authentication, security, billing, session tracing, mobility, etc. As a consequence, the WiFi access point 22 and the eNB 12, no longer need to include their own distinct RRC functionality.

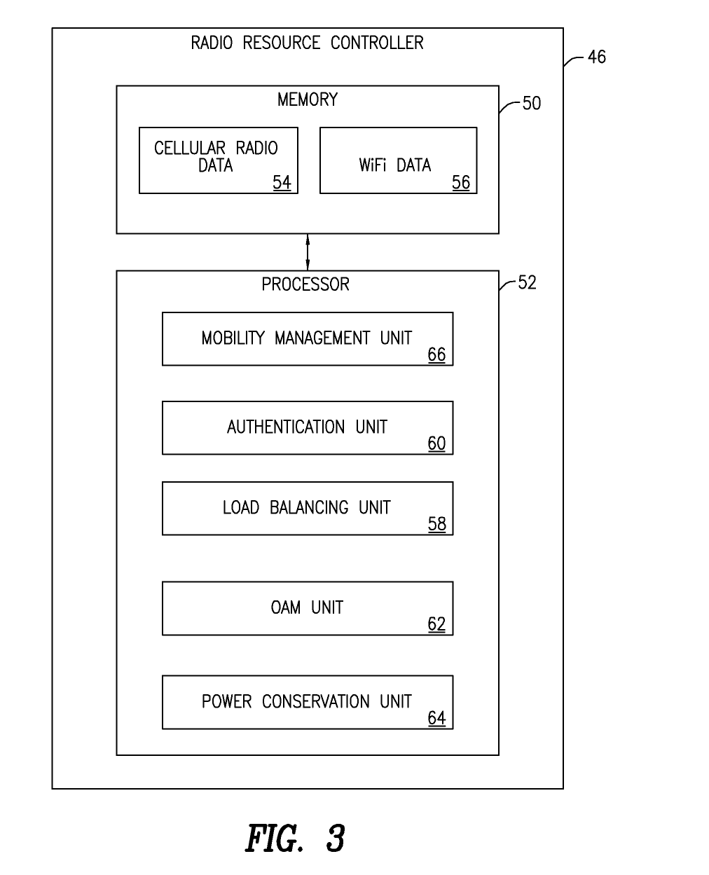

FIG. 3 is a block diagram of an exemplary radio resource controller 46. The radio resource controller 46 includes a memory 50 and a processor 52. The memory 50 stores data 54 relevant to control of the cellular radio network and data 56 relevant to control of the WiFi network. For example, the cellular radio data 54 may include data corresponding to a first load on a cellular radio base station, and WiFi data 56 may include data corresponding to a second load on a WiFi access point. Such load data may include a total number of user devices being served by the cellular radio base station or WiFi access point. A load balancing function 58 performed by the processor 52 may reallocate traffic between the cellular radio base station and the WiFi access point based on the first and second load data.

As another example, the data 54 may include first authentication data for determining authentication of a user equipment to access the cellular radio network and the data 56 may include second authentication data for determining authentication of the user equipment 36 to access the WiFi network. For example, the first authentication data may include a password for access to the cellular radio network and the second authentication data may include a password for access to the WiFi network. An authentication function 60 performed by the processor 52 authenticates the user equipment 36 to the cellular radio network and to the WiFi network.

As another example, the data 54 may include first operations, administration and maintenance, OAM, data concerning packets from the cellular radio base station and data 56 may include OAM data concerning packets from the WiFi access point. For example, the first OAM data may include a volume of traffic of a UE with the cellular radio network, and the second OAM data may include a volume of traffic of the UE with the WiFi network. An OAM unit 62 processes the first and second OAM data. For example, the OAM functions 52 may include billing functions based on use of the cellular radio network by a user equipment and may include billing functions based on use of the WiFi network by the user equipment.

The processor 52 may further include a power conservation unit 64 that functions to direct a user equipment 36 to conserve power by, for example, entering a sleep mode. For example, if a particular user equipment is not currently communicating over the WiFi network, the power conservation unit 64 may instruct the WiFi electronics of the user equipment 36 to enter a sleep mode, while the cellular radio electronics of the user equipment 36 remain fully active. Thus, the power conservation unit 64 may independently cause power down of one or both of the cellular radio electronics and the WiFi electronics of the user equipment.

The processor 52 may further include a mobility management unit 66 to control handoff of a user equipment from the cellular radio network to the WiFi network or from the WiFi network to the cellular radio network. The mobility management unit 66 may work in conjunction with the load balancing unit 58 to handoff a user equipment 36 based on a determination by the load balancing unit 58 that a load on a cellular base station is high, whereas a load on a WiFi access point serving an overlapping geographic area is low. Further, the mobility management unit 66 may function to perform admission control for admitting a user equipment 36 to the cellular radio network and to the WiFi network. Such admission control includes determining if there are sufficient radio resources to enable a session that includes the user equipment to be set up.

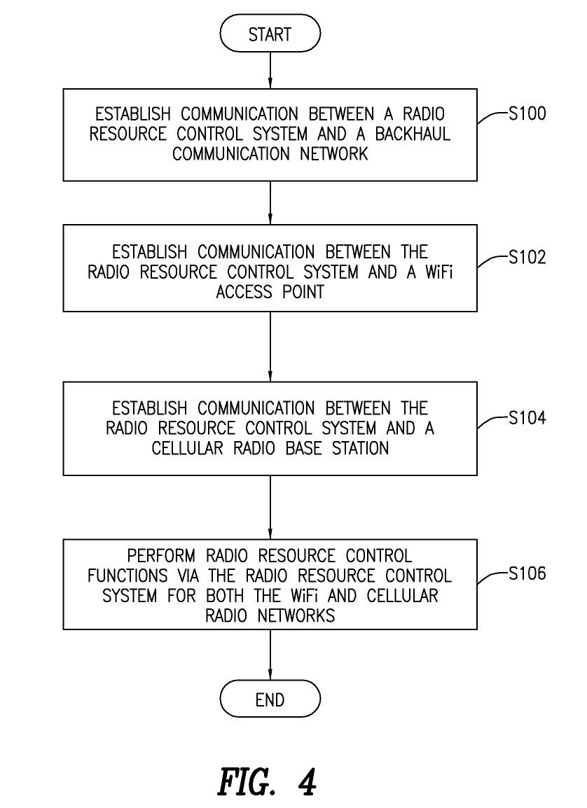

FIG. 4 is a flowchart of an exemplary process for controlling a combining radio resource system for cellular radio resources and WiFi resources. Communication is established between a radio resource control system 30 and a backhaul network, (block S100). Communication is also established between the radio resource control system 30 and a WiFi access point 32, (block S102). Communication is also established between the radio resource control system 30 and a cellular radio base station 34, such as an eNB, (block S104). The radio resource control system 30 performs one or more of the radio resource control functions described above for both WiFi and cellular radio networks, (block S106). For example, the radio resource control functions may include mobility management, authentication, load balancing, OAM functions, and power conservation functions as discussed herein.

Thus, embodiments described herein provide integrated control and management of cellular radio and WiFi resources and end user sessions. Note that the RRC 46 may be located at a base station of the cellular radio network or may be located remote from the base station. Alternatively, the RRC 46 may be located at a WiFi access point. The RRC 46 may perform mapping of Internet protocol, IP, flows visible to the WiFi access point to cellular radio bearers and may further coordinate quality of service, QoS, profiles for both networks. Further, a network operator can monitor and measure the radio coverage characteristics of the WiFi network using infrastructure already deployed for LTE or other cellular radio network. WiFi measurement reports may be handled in the same way as LTE measurement reports, i.e., through an operators' network management system.

By employing the approaches described herein, both the cellular radio network and the WiFi network can be managed by the existing cellular radio network OAM infrastructure. Mobility may be controlled by a single entity that controls both air interface technologies. Mobility between the technologies is no longer a complex task spread across two independent networks spanning multiple nodes in each network. As a consequence, the cellular radio base station and the WiFi access point are simplified since they may not include their own distinct RRC functions. Managing large numbers of cellular radio cells and WiFi access points is simplified since they are treated as peer cells from an operations and administration point of view.

Active user bearers can, for example, be split across 4G LTE and WiFi simultaneously. The RRC function can make intelligent decisions on what RAT has the necessary resources able to best satisfy each bearer QoS characteristics at any instant in time, and create or move individual data bearers of a user session between RATs without affecting the other bearers belonging to that session. In other words, it is contemplated that the RRC system 30 is configured to move individual services associated with a user session between the cellular radio and WiFi networks.

The present invention can be realized in hardware, or a combination of hardware and software. Any kind of computing system, or other apparatus adapted for carrying out the methods described herein, is suited to perform the functions described herein. A typical combination of hardware and software could be a specialized computer system, having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A method of providing combined control and management of radio resources of a cellular radio network and a WiFi network, the cellular radio network having at least one cellular radio base station, and the WiFi network having at least one WiFi access point, the method comprising:
establishing communication between a combined radio resource control system and at least one cellular radio base station;
establishing communication between the combined radio resource control system and at least one WiFi access point; and
establishing communication between the combined radio resource control system and a backhaul communication network; and
performing, by the combined radio resource control system, radio resource control functions controlling utilization of radio resources of the cellular radio network and the WiFi network.

2. The method of claim 1, wherein the radio resource control functions include mobility functions performed to handoff a user equipment from one of the at least one cellular radio base stations to one of at the least one WiFi access points.

3. The method of claim 1, wherein the radio resource control functions include mobility functions performed to handoff a user equipment from one of the at least one WiFi access points to one of the at least one cellular radio base stations.

4. The method of claim 1, wherein the radio resource control functions include authentication functions performed to authenticate a user equipment to the cellular radio network and to authenticate a user equipment to the WiFi network.

5. The method of claim 1, wherein the radio resource control functions include load balancing functions to allocate traffic between the cellular radio network and the WiFi network.

6. The method of claim 1, wherein the radio resource control functions include operations, administration and maintenance functions performed in relation to packets received from at least one of the at least one cellular radio base station and from at least one of the at least one WiFi access point.

7. The method of claim 6, wherein the operations, administration and maintenance functions include at least one of billing, security and tracing of packets transmitted by the at least one cellular radio base station and by the at least one WiFi access point.

8. The method of claim 1, wherein the radio resource control functions include power saving functions performed to conserve power in user equipment accessing at least one cellular radio base station and in user equipment accessing at least one WiFi access point.

9. The method of claim 1, wherein the radio resource control functions include admission control functions performed to admit a user equipment to the cellular radio network and to the WiFi network.

10. A combined radio resource control system to control and manage radio resources of a cellular radio network associated with at least one cellular radio base station and a WiFi network associated with at least one WiFi access point, the combined radio resource control system comprising:
a communication interface configured to communicate with the at least one WiFi access point according to a WiFi compatible protocol and to communicate with the at least one cellular radio base station according to a cellular radio compatible protocol;
a translator configured to translate packets received from the at least one WiFi access point to packets compatible with a first communication protocol; and
a radio resource controller configured to perform radio resource control functions for both the cellular radio network and the WiFi network according to the first communication protocol.

11. The combined radio resource control system of claim 10, wherein the first protocol is the cellular radio compatible protocol.

12. The combined radio resource control system of claim 10, wherein the radio resource controller includes a mobility management unit configured to perform handoff of a user equipment between the cellular radio network and the WiFi network.

13. The combined radio resource control system of claim 10, wherein the radio resource controller includes an authentication unit to authenticate a user equipment to the cellular radio network and to authenticate a user equipment to the WiFi network.

14. The combined radio resource control system of claim 10, wherein the radio resource controller includes a load balancing unit to balance a load on the cellular radio network with a load on the WiFi network.

15. The combined radio resource control system of claim 10, wherein the radio resource controller includes an operations, administration and maintenance, OAM, unit to perform operations, administration and maintenance functions in relation to packets received from the cellular radio network and from the WiFi network.

16. The combined radio resource control system of claim 10, further comprising a packet data convergence protocol unit operable to compress, and decompress, IP headers of packets transmitted to, and received from, the translator, respectively.

17. A radio resource controller, comprising:
a memory configured to store:
first data corresponding to a first load on a cellular radio base station of a cellular radio network; and
second data corresponding to a second load on a WiFi access point of a WiFi network; and
a processor configured to:
determine a reallocation of traffic between the cellular radio base station and the WiFi access point based on the first and second data.

18. The radio resource controller of claim 17, wherein:
the memory is further configured to store:
first authentication data for determining authentication of a user equipment to access the cellular radio network; and
second authentication data for determining authentication of the user equipment to access the WiFi network; and
the processor is further configured to:
authenticate the user equipment to the cellular radio network based on the first authentication data; and
authenticate the user equipment to the WiFi network based on the second authentication data.

19. The radio resource controller of claim 17, wherein:
the memory is further configured to store:
first channel quality information for a first channel of the cellular radio base station; and
second channel quality information for a second channel of the WiFi access point; and
the processor is further configured to:
perform a handoff of a user equipment between the first channel and the second channel based on the first channel quality information and the second channel quality information.

20. The radio resource controller of claim 17, wherein:
the memory is further configured to store:
first operations, administration and maintenance, OAM, data concerning packets from the cellular radio base station; and
second OAM data concerning packets from the WiFi access point; and
the processor is further configured to:
perform OAM functions based on the first OAM data and the second OAM data.
